(19) United States
(12) Patent Application Publication
(10) Pub. No.: US 2014/0001927 A2
(43) Pub. Date: Jan. 2, 2014

(54) RECTIFIERARRANGEMENT HAVING SCHOTTKY DIODES

(71) Applicant: Alfred GOERLACH, Kusterdingen (DE)

(72) Inventor: Alfred GOERLACH, Kusterdingen (DE)

(73) Assignee: Robert Bosch GmbH, Stuttgart, DE (DE)

(21) Appl. No.: 13/814,161

(22) PCT Filed: Jun. 7, 2011
(86) PCT No.: PCT/EP2011/059342

§ 371 Date: Apr. 9, 2013

(30) Foreign Application Priority Data
Aug. 4, 2010 (DE) 10 2010 038 879.3

(51) Int. Cl. H02K 11/04

(52) U.S. Cl. CPC H02K 11/046
USPC 310/68 D

(57) ABSTRACT

A rectifier system having press-in diodes that contain a Schottky diode as semiconductor element. The Schottky diodes are operated in an operating range in which the diode losses increase as the temperature increases.

### FIELD

The present invention relates to a rectifier system having diodes, in particular press-in diodes. Such a rectifier system is used in particular in motor vehicle generator systems.

### BACKGROUND INFORMATION

In motor vehicle generator systems, diodes made of silicon are generally used for the rectification of the alternating or rotary current. For example, six diodes are connected together to form a B6 rectifier bridge. These diodes are usually realized as so-called press-in diodes. Press-in diodes are pressed into the cooling element of the rectifier on one side, and are thus fixedly and permanently connected, electrically and thermally, to the cooling element of the rectifier.

During rectifier operation, at the diodes there is dropped an electrical power loss Pel that is made up of forward or on-state losses PF and reverse losses PR, and is converted into heat. This heat is dissipated via the rectifier, at the cooling or suction air of the generator. Because the cooling power of motor vehicle generators is still relatively small at low generator rotational speeds, while on the other hand the electrical power output increases rapidly as the generator rotational speed increases, there exists a rotational speed, usually in the range of 2500-3500 rotations per minute, at which the diode temperatures are at their highest. This operating point is referred to as the hot point. The maximum permissible barrier layer temperature of the diodes must be designed at least for operation in the hot point.

For a symmetrical rectifier system, such as for example in a B6 bridge, the average electric forward power loss PF results from the product of the arithmetic mean of the on-state or forward current IFAV and the temperature-dependent forward voltage UF(T) of a diode, as:

PF=IFAV·UF(T) (1)

In diodes used in motor vehicles, forward voltage UF(T) generally decreases with the temperature. In the relevant current range, temperature coefficient TKUF is for example approximately −1 mV/K.

Forward losses PF can be reduced if, instead of standard pn diodes, Schottky diodes are used having lower forward voltage UF. The lower forward losses of the Schottky diodes cause an increase in efficiency and output power of the generator. Particularly advantageously, so-called high-efficiency diodes (HEDs) are used, which have a reverse current that is not a function of the reverse voltage. HEDs are for example trench MOS barrier Schottky diodes (TMBS) or trench junction barrier Schottky diodes (TJBS). Such diodes are described for example in German Patent No. DE 694 28 996 T2 and in German Patent Application No. DE 10 2004 053 761 A1.

While in standard pn diodes the reverse losses are generally negligible, in Schottky diodes or HEDs significant reverse losses occur at high temperatures due to the low forward voltage. For average reverse losses PR, the following holds at a reverse voltage UR that corresponds approximately to the generator voltage:

PR=0.5·IR(T)·UR (2)

At a given reverse voltage UR, reverse current IR(T) is also a function of the temperature. It increases rapidly with the temperature. In the relevant temperature range, the reverse current can be expressed using two constants Ioo and Ea. Ioo describes the current given infinitely high temperature, in amperes, and Ea describes the activation energy, in Kelvin. The following holds:

$$IR ( T ) \approx Ioo \cdot {e}^{- ( \frac{Ea}{T} )} \qquad ( 3 )$$

With the indicated functional relationships, FIG. 1 shows a diagram for the average overall power loss P(W) of an HED at a forward current IFAV=50 A and a reverse voltage UR=14V, plotted over barrier layer temperature Tj. Here, a diode was selected having the parameters Ioo=4·10⁷ A and Ea=9300K.

At low temperatures, the reverse losses can be ignored relative to the forward losses. Because, due to the negative temperature coefficient, the forward voltage decreases as the temperature increases, the system is thermally stable. At higher temperatures, reverse losses PR increase, and finally even exceed forward losses PF. After this, the overall power loss P(W) increases as the temperature increases. FIG. 1 indicates, as turning point A, the point from which the overall power loss increases with the temperature. The barrier layer temperature of turning point A is designated TA. In the example shown, TA=200° C.

If barrier layer temperature Tj exceeds this turning point at TA, there is the danger of a thermal instability, because due to the reverse current increase the reverse currents can continue to increase as the temperature increases. This corresponds to a thermal running away due to the occurrence of a feedback effect of the reverse current.

For the reasons stated above, rectifier systems that contain Schottky diodes realized as press-in diodes are always operated in an operating range that is below turning point A, i.e., in an operating range in which the diode losses decrease as the temperature increases.

### SUMMARY

In an example rectifier system in accordance with the present invention, the operating range of the rectifier system is enlarged. This is generally achieved in that the rectifier system is operated not only in an operating range in which the diode losses decrease as the temperature increases, but also in a range in which the diode losses increase again as the temperature increases. Here, through a design specification explained below, it is achieved that the rectifier system can be reliably operated even in the range in which the diode losses again increase as the temperature increases.

### BRIEF DESCRIPTION OF THE DRAWINGS

Below, the present invention is explained in more detail on the basis of FIGS. 2 through 5.

FIG. 2 shows a rectifier system having a total of six Schottky diodes connected in the form of a B6 bridge.

FIG. 3 shows a design of a press-in diode.

FIG. 4 shows a trench MOS barrier Schottky diode.

FIG. 5 shows a diagram explaining the operating range of a rectifier system according to the present invention.

### DETAILED DESCRIPTION OF EXAMPLE EMBODIMENTS

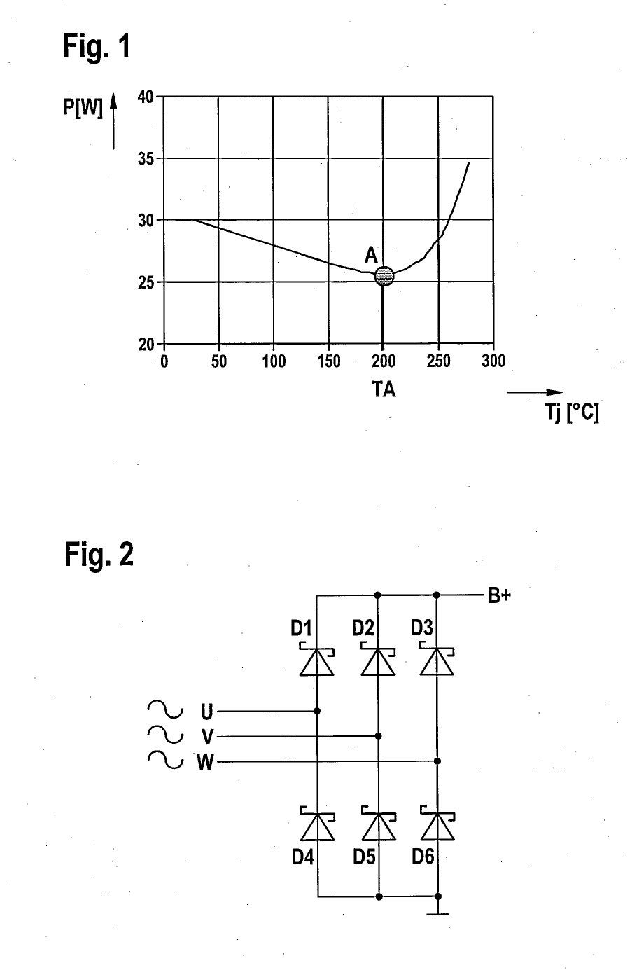

FIG. 2 shows a rectifier system having a total of six Schottky diodes D1 through D6, connected to one another in the form of a B6 bridge. This rectifier bridge circuit is provided for a three-phase motor vehicle generator. The phase connections of the bridge circuit are designated U, V, W, and B+ designates the positive direct current source of the bridge circuit. Of course, rectifier systems having a different number of phases, for example five, six, or seven phases, are also possible.

The rectifier diodes of the rectifier system shown in FIG. 2 are mounted in press-in housings. The rectifier diodes can in particular be press-in diodes that contain at least one Schottky diode as semiconductor element.

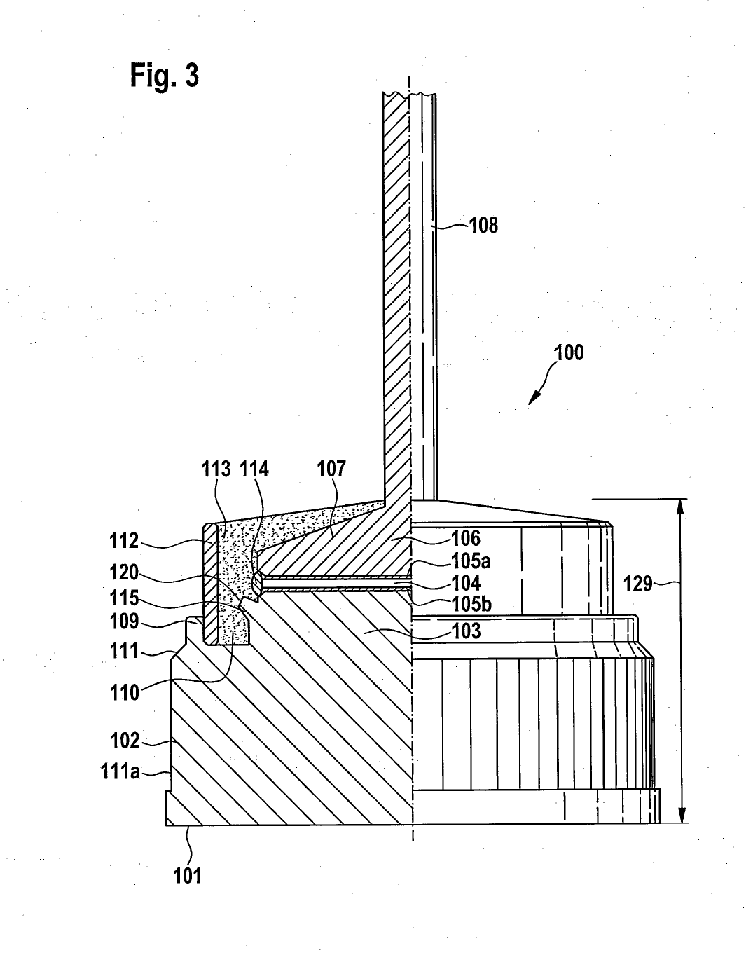

FIG. 3 shows the design of a standard press-in diode 100, shown in a partly sectioned cross-sectional view. This diode 100 has a base 102 having a base floor 101. To base 102 there is connected, in one piece, a platform 103 on which a semiconductor chip is attached, for example by soldering (solder 105b). Semiconductor chip 104 is for example in turn connected by soldering (solder 105a) to a tip wire 108, via a tip cylinder 106 and a tip cone 107. Platform 103, preferably situated in centered fashion, is surrounded by a circumferential wall 109 and a trench 110 formed by wall 109 and platform 103. Regarded from platform 103, on the other side of wall 109 there is another press region 111 that is connected to edge region 111a, on which forces perpendicular to the plane of semiconductor chip 104 can act during the pressing in of rectifier diode 100. Tip ball 107, tip cylinder 106, semiconductor chip 104, and platform 103 are surrounded by a packaging 113 that is limited by a protective sleeve 112. Platform 103 and head cylinder 106 have a bevel on their edge that is oriented toward the semiconductor chip. The bevels can for example be filled with solder. In addition, on the edge of the chip there is attached a passivation 114 that seals the chip and the solder on the chip edge. In addition, platform 103 has a circumferential shoulder 115 having an oblique edge 120 that extends into packaging 113.

In rectifier diode 100 shown in FIG. 3, semiconductor chip 104 is fastened to a raised platform 103 that is surrounded by a wall 109. Trench 110 formed in this way has a length that is twice the height of wall 109. The advantage of this is that the construction is particularly robust against deformations during the pressing in of the rectifier diode. The combination of the platform and the wall/trench ensures a more homogenous and lower bending stress on the chip support surface, compared to a construction not having a significant wall formation 109. A further advantage is that the chip centering is not critical. Preferably, the wall is lower than the platform; among other reasons, this is so as not to impair access to the chip during the production of the diode and during passivation.

According to FIG. 3, rectifier diode has a shoulder 115 on its base 102, for example on the circumference of platform 103. This shoulder creates a positive fit of the packaging with the base. On the one hand, this results in mechanical stability, in that the base is in a certain sense hooked onto packaging 113. On the other hand, a packaging realized for example as a cast resin molding presses the tip part of the diode, together with the semiconductor chip, onto the base during production, when the tip part of the diode dries out. Overall, this results in a stable construction. Here, shoulder 115 has an oblique edge 120 that prevents the occurrence of high mechanical tensions and the danger of crack formation in the packaging in the case of external mechanical, but also thermal, stresses; this danger would exist if the shoulder had an end that runs to a point.

Of course, other variants of press-in diodes may also be used.

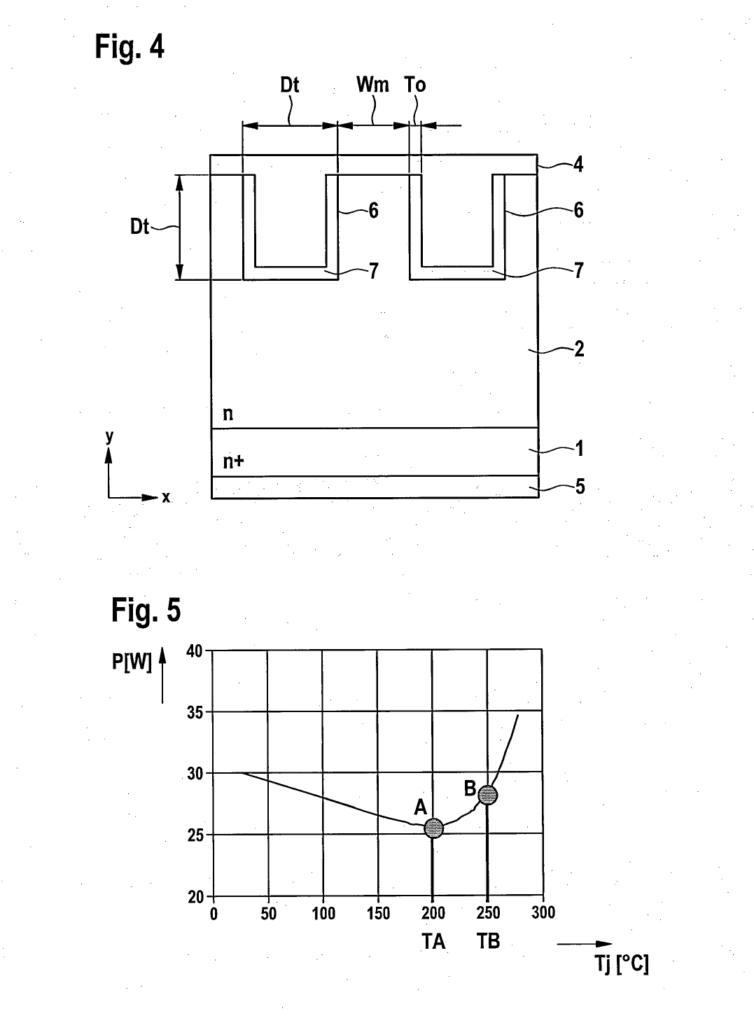

FIG. 4 shows a drawing illustrating a trench MOS barrier Schottky diode (TMBS diode) preferably used in a rectifier system according to the present invention.

Such a TMBS diode is made up of an n+ substrate 1, an n-epilayer 2, at least two trenches 6 realized in the n-epilayer by etching, metal layers on front side 4 of the chip as anode electrode and on rear side 5 of the chip as cathode electrode, and an oxide layer 7 between trenches 6 and the metal layer on front side 4.

Regarded electrically, a TMBS diode is a combination of an MOS structure (metal layer, oxide layer 7, and n-epilayer 2) and a Schottky diode (Schottky barrier between the metal layer as anode and n-epilayer 2 as cathode).

In the forward direction, currents flow through the mesa region between trenches 6. Trenches 6 themselves are not available for the flow of current.

The advantage of a TMBS diode lies in the reduction of the reverse currents. In the reverse direction, space charge zones form both in the MOS structure and in the Schottky diode. The space charge zones expand as the voltage increases, and, at a voltage that is smaller than the breakdown voltage of the TMBS, meet one another in the center of the region between adjacent trenches 6. In this way, the Schottky effects responsible for the high reverse currents are shielded and the reverse currents are reduced. This shielding effect is strongly functionally dependent on structural parameters Dt (depth of the trench), Wm (distance between the trenches), Wt (width of the trench), and To (thickness of the oxide layer).

In a rectifier having diodes, in particular press-in diodes, the thermal resistance of the rectifier that arises for example during operation in the hot point of a generator can be kept stably below a particular value over the entire operational time period, because the thermal characteristics of the robust press-in contact practically do not change.

The power loss produced by electrical reverse currents IR(T) is dissipated as heat via the rectifier, i.e., the electric power loss of each diode Pel must be dissipated via the rectifier to the ambient air as thermal power Ptherm. Ptherm corresponds to the quotient of the temperature difference dT between barrier layer temperature Tj and ambient or cooling air temperature Ta and the thermal resistance Rth between the barrier layer and the ambient air. The thermal resistance changes with the generator rotational speed and therefore here designates the thermal resistance that occurs during operation in the hot point. A diode is thermally stable as long as the following holds:

$$\frac{d PeI}{d T} \leq \frac{d Ptherm}{d T} \qquad ( 4 )$$

Because forward losses PF of a diode have a negative temperature coefficient, they can be ignored in equation (4).

With the reverse current functional relationship from equation (3), reliable operation is possible at high temperatures without thermal runaway according to equation (4), if the following holds:

$$\frac{1}{2} \cdot UR \cdot Rth \cdot \frac{Ea}{{T}^{2}} \cdot IR ( T ) \leq 1 \qquad ( 5 )$$

FIG. 5 shows a diagram illustrating the operational range of a rectifier system according to the present invention. Here, as in FIG. 1, temperature Tj (° C.) is plotted along the abscissa, and overall power loss P(W) is plotted along the ordinate. In this exemplary embodiment, for a diode of the rectifier a thermal resistance Rth is shown between the barrier layer of the diode and cooling air of 5 Kelvin/Watt for a reverse voltage UR=14V and a forward current IFAV=50A. The diode can be operated well beyond the conventional barrier layer temperature boundary. In the depicted example, the maximum barrier layer temperature TA of 200° C. is expanded up to a temperature TB of almost 250° C. This means that the operating range in which the Schottky diodes can be operated also extends to the temperature range in which the diode losses again increase as the temperature increases.

The thermal resistance between the barrier layer of the semiconductor and the ambient air during operation in the hot point of the generator does not exceed a specified value. For example, the named thermal resistance is less than 7 K/W, preferably less than 5 K/W, and particularly preferably less than 3 K/W.

As stated above, the maximum permissible barrier layer temperature of a diode is determined according to the following equation:

$$\frac{1}{2} \cdot UR \cdot Rth \cdot \frac{Ea}{{T}^{2}} \cdot IR ( T ) \leq 1.$$

As stated above, as Schottky diodes trench MOS barrier Schottky diodes are preferably used whose trench depth is 1 μm to 3 μm and whose distance from trench to trench is from 0.5 μm to 1 μm.

Alternatively, as Schottky diodes trench junction barrier Schottky diodes (TJBS diodes) may be used whose trench depth is 1 μm to 3 μm and whose distance from trench to trench is from 0.5 μm to 1 μm.

Preferably, the Schottky diodes are diodes having a Schottky barrier of from 0.65 eV to 0.75 eV.

What is claimed is:

1-10. (canceled)

11. A generator having a rectifier system having press-in diodes that each contain as a semiconductor element a Schottky diode, the generator having a hot point at which, as a function of a rotational speed of the generator, a temperature of the diodes is at its highest, wherein a thermal resistance between a barrier layer of a semiconductor of the semiconductor element and an ambient air during operation in the hot point of the generator does not exceed a specified value, the diodes being configured so that a maximum permissible barrier layer temperature of the diodes is at least for operation in the hot point, and the Schottky diodes are operated in an operational range in which the diode losses increase with increasing temperature.

12. The generator as recited in claim 11, wherein, in the hot point, the maximum permissible barrier layer temperature T of the diodes satisfies the following equation:
$$\frac{1}{2} \cdot UR \cdot Rth \cdot \frac{Ea}{T \overline{2}} \cdot IR ( T ) \leq 1$$
where Rth is the thermal resistance, UR is a barrier voltage, IR(T) is a barrier current, T is a temperature of the barrier layer and Ea is an activation energy.

13. The generator as recited in claim 11, wherein the thermal resistance between the barrier layer of the semiconductor and ambient air at the operation in the hot point of the generator is less than 7 K/W.

14. The generator as recited in claim 11, wherein the thermal resistance between the barrier layer of the semiconductor and the ambient air at the operation in the hot point of the generator is less than 5 K/W.

15. The generator as recited in claim 11, wherein the thermal resistance between the barrier layer of the semiconductor and ambient air at the operation in the hot point of the generator is less than 3 K/W.

16. The generator as recited in claim 11, wherein the Schottky diode is a trench MOS barrier Schottky diode.

17. The generator as recited in claim 16, wherein the Schottky diode is a trench MOS barrier Schottky diode, in which a trench depth is 1-3 μm and a distance from trench to trench is 0.5-1 μm.

18. The generator as recited in claim 11, wherein the Schottky diode is a trench junction barrier Schottky diode.

19. The generator as recited in claim 18, wherein the Schottky diode is a trench junction barrier Schottky diode, in which a trench depth is 1-3 μm and a distance from trench to trench is 0.5-1 μm.

20. The generator as recited in claim 11, wherein the Schottky diodes are diodes having a Schottky barrier of 0.65 eV to 0.75 eV.
